(19) United States
(12) Patent Application Publication
(10) Pub. No.: US 2010/0122780 A1
(43) Pub. Date: May 20, 2010

(54) SCREEN ROLLING DEVICE

(75) Inventor: Li-Ming Cheng, Kaohsiung City (TW)

Correspondence Address: VOLENTINE & WHITT PLLC, ONE FREEDOM SQUARE, 11951 FREEDOM DRIVE SUITE 1260, RESTON, VA, 20190, US

(73) Assignee: ZIPSHADE INDUSTRIAL (B.V.I.) CORP., Tortola (VG)

(21) Appl. No.: 12/272,970

(22) Filed: Nov. 18, 2008

(51) Int. Cl. E06B 9/90; E06B 9/78

(52) U.S. Cl. 160/305

(57) ABSTRACT

The present invention relates to a screen rolling device, which includes a winding roller, an inner shaft, at least one metal strip roll and a screen. The inner shaft is located in the winding roller. The metal strip roll is wound around the inner shaft and has a first end and a second end. The first end is fixed to the inner shaft, and the second end drives the winding roller to rotate relatively to the inner shaft. The screen is wound around the winding roller and has a first end and a second end. The first end is fixed to the winding roller, and the second end is a free end. Therefore, the length of the screen pulled down by a user is the desired length and does not need further adjustment.

### BACKGROUND OF THE INVENTION

1. Field of the Invention

The present invention relates to a screen rolling device, and more particularly to a screen rolling device capable of accurately positioning the screen.

2. Description of the Related Art

FIG. 1 shows a schematic view of a conventional screen rolling device. The device 1 includes a winding roller 11, a transmission mechanism (not shown), a screen 12, a first support frame 13, a second support frame 14, and a bottom cross bar 15. The transmission mechanism is located in the winding roller 11, and includes at least an elastic element and a catching element.

The screen 12 is wound around the winding roller 11. The screen 12 has a first end (not shown) and a second end 122. The first end is fixed to the winding roller 11, and the second end 122 is a free end. The first support frame 13 and the second support frame 14 respectively support the two ends of the winding roller 11. The bottom cross bar 15 is located at the second end 122 of the screen 12.

The conventional screen rolling device 1 operates as follows. When a user intends to unroll the screen 12, he/she only has to pull down the bottom cross bar 15 manually to cause the winding roller 11 to rotate, and thus the screen 12 is continuously unrolled. Then, the user just releases the bottom cross bar 15 when the screen 12 is unrolled to a desired length. Meanwhile, driven by the elastic element, the winding roller 11 starts to rotate inversely to wind up the screen 12, and stops when kept by the catching element at a particular position, as shown in FIG. 2.

The conventional screen rolling device 1 has the following disadvantage. In the above process, after the bottom cross bar 15 is released, the winding roller 11 starts to rotate inversely to wind up the screen 12 by a length of D (FIG. 2). Thus, at this time, the unrolled length of the screen 12 is no longer the length drawn down at the beginning. Generally, the bottom cross bar 15 must be drawn down again by a length greater than the length D, and then released to see if a desired unrolled length of the screen 12 is obtained when the winding roller 11 stops rotating. If not, the unrolled length of the screen 12 must be repeatedly adjusted. Therefore, it is quite inconvenient in use.

Therefore, it is necessary to provide a screen rolling device to solve the above problem.

### SUMMARY OF THE INVENTION

The present invention is directed to a screen rolling device comprising a winding roller, an inner shaft, at least one metal strip roll and a screen. The inner shaft is located in the winding roller. The metal strip roll is wound around the inner shaft and has a first end and a second end. The first end is fixed to the inner shaft, and the second end drives the winding roller to rotate relative to the inner shaft. The screen is wound around the winding roller and has a first end and a second end. The first end is fixed to the winding roller, and the second end is a free end. Therefore, the length of the screen pulled down by a user is the desired length and does not need further adjustment.

### BRIEF DESCRIPTION OF THE DRAWINGS

FIG. 1 is a schematic view of a conventional screen rolling device;

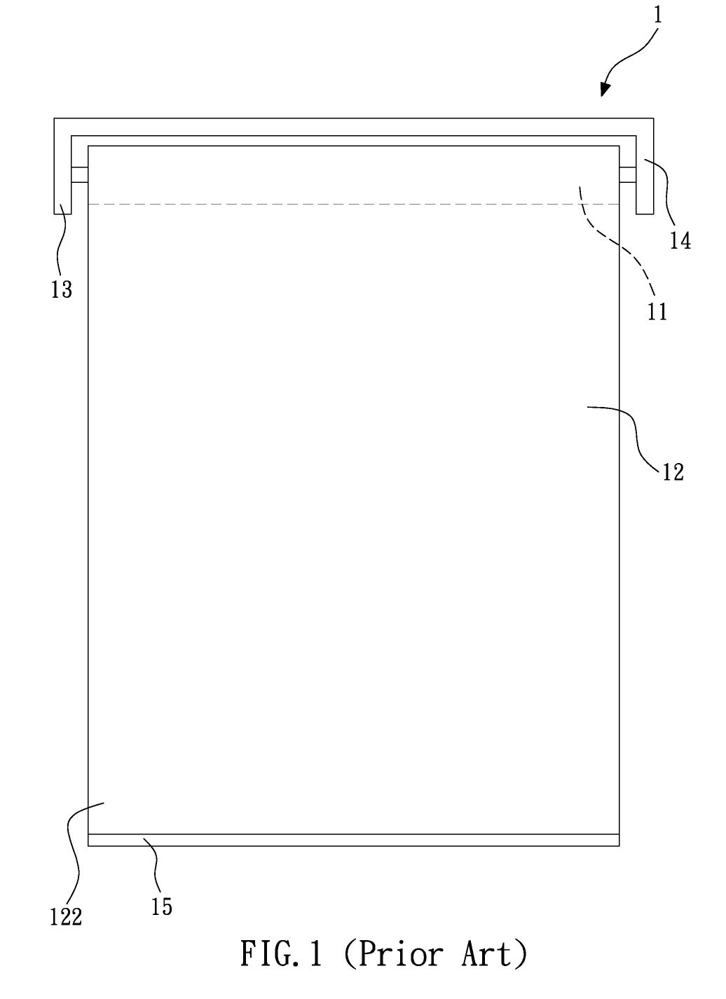

FIG. 2 is a schematic view showing the operation of the conventional screen rolling device;

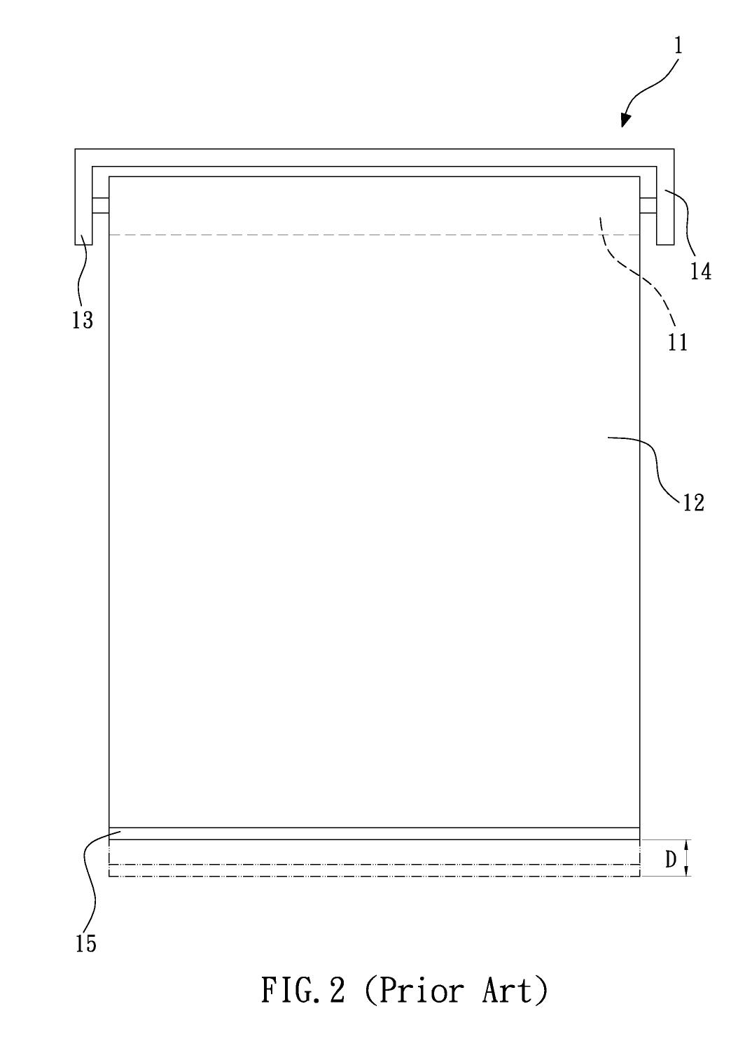

FIG. 3 is a schematic perspective assembly view of a screen rolling device according to a preferred embodiment of the present invention;

FIG. 4 is a schematic perspective exploded view of a screen rolling device according to a preferred embodiment of the present invention;

FIG. 5 is a schematic perspective exploded views of a screen rolling device according to a preferred embodiment of the present invention, in which some of the elements are assembled;

FIG. 6 is a schematic perspective exploded view of an inner sleeve, a first metal strip roll, a second metal strip roll and an inner shaft according to the present invention;

FIG. 7 is a schematic view showing the operation of a screen rolling device according to the present invention;

FIG. 8 is a perspective exploded view of a tension adjustment device according to the present invention; and

FIGS. 9 and 10 are schematic views showing the operation of the tension adjustment device according to the present invention.

### DETAILED DESCRIPTION OF THE INVENTION

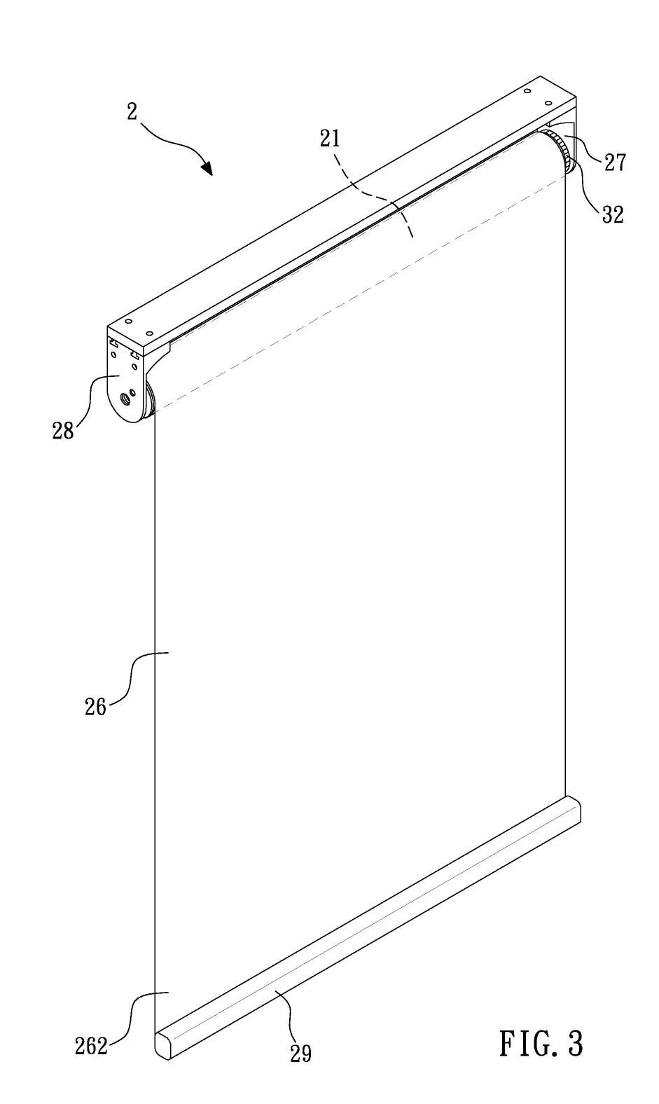

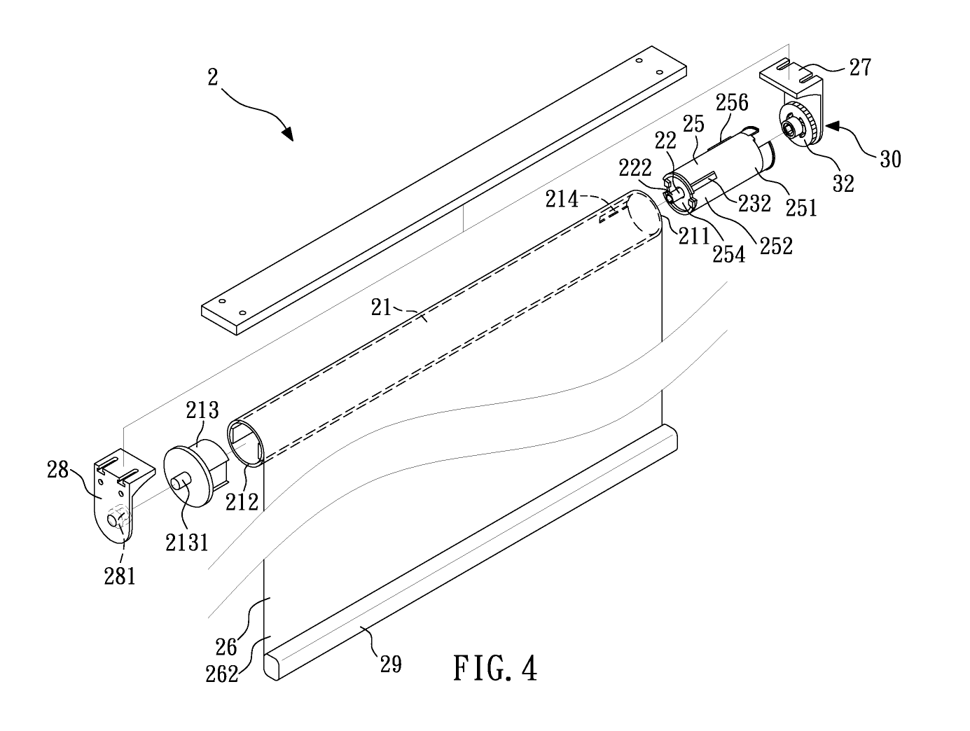

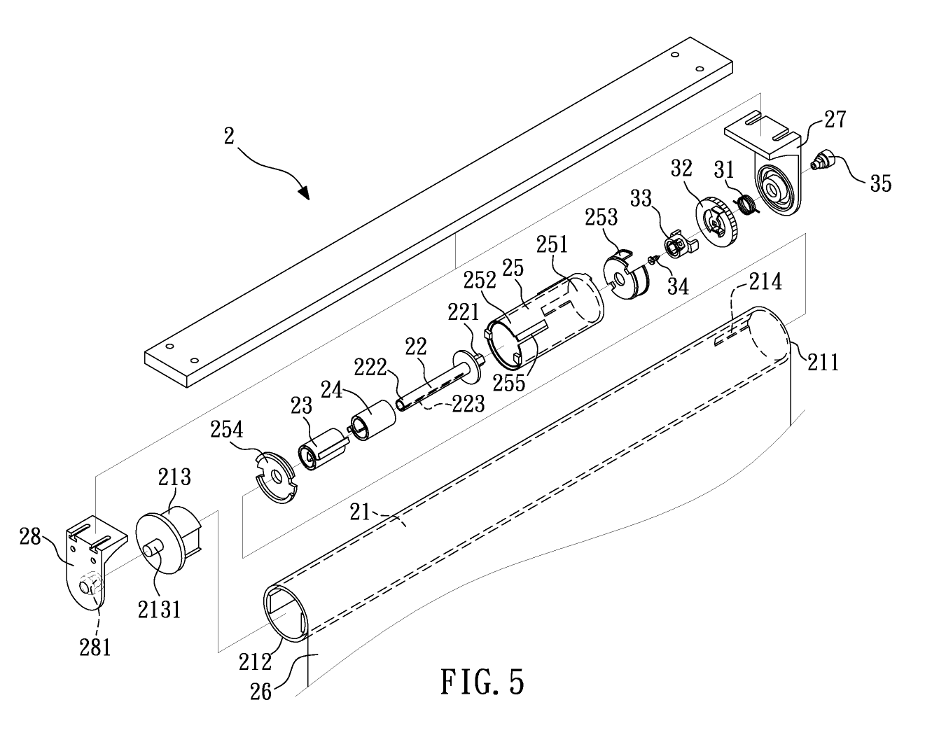

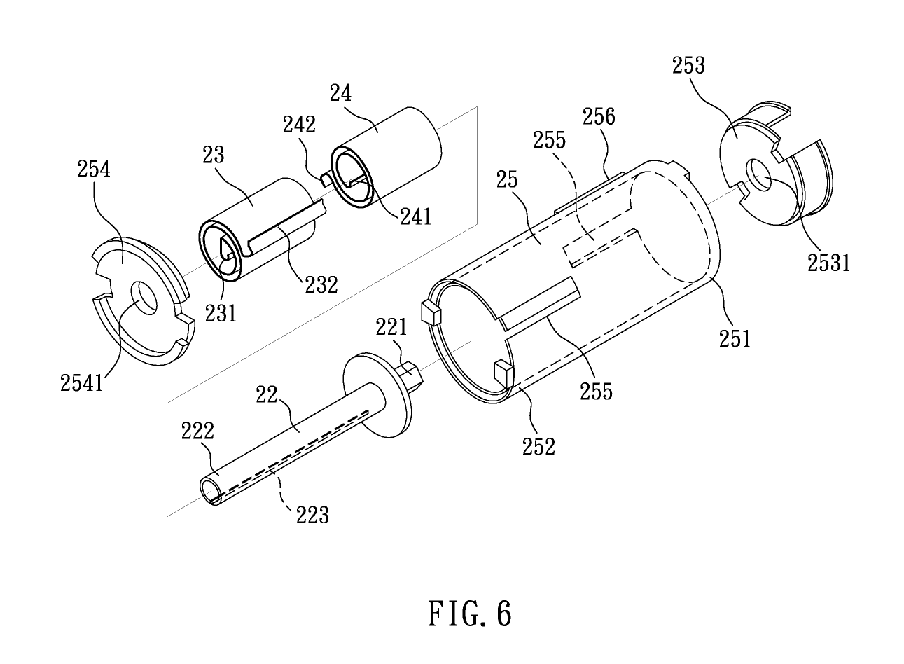

FIG. 3 shows a schematic perspective assembly view of a screen rolling device according to a preferred embodiment of the present invention. FIGS. 4 and 5 show schematic perspective exploded views of a screen rolling device according to a preferred embodiment of the present invention. FIG. 6 shows a schematic perspective exploded view of an inner sleeve, a first metal strip roll, a second metal strip roll and an inner shaft according to the present invention.

The screen rolling device 2 comprises a winding roller 21, an inner shaft 22, at least one metal strip roll (a first metal strip roll 23 and a second metal strip roll 24), an inner sleeve 25, a screen 26, a first support frame 27, a second support frame 28 and a bottom cross bar 29. The winding roller 21 has a first end 211, a second end 212, a third side cover 213 and a retaining slot 214. The third side cover 213 has a short pin 2131. The third side cover 213 is engaged with the second end 212 of the winding roller 21, and the axis of the short pin 2311 is the same as that of the winding roller 21.

The inner shaft 22 is located in the winding roller 21. The inner shaft 22 comprises a first end 221, a second end 222 and a first slot 223.

The inner sleeve 25 accommodates the inner shaft 22 and the metal strip roll (the first metal strip roll 23 and the second metal strip roll 24). That is, the inner shaft 22 and the metal strip roll (the first metal strip roll 23 and the second metal strip roll 24) are located in the inner sleeve 25. The inner sleeve 25 is engaged with the winding roller 21, so as to rotate together with the winding roller 21.

In this embodiment, the inner sleeve 25 comprises a first end 251, a second end 252, a first side cover 253, a second side cover 254, at least one second slot 255 and a protrusion 256. The protrusion 256 is located on a surface of the inner sleeve 25, and is engaged with the retaining slot 214 of the winding roller 21. The first side cover 253 is engaged with the first end 251 of the inner sleeve 25, and has a first through-hole 2531. The second side cover 254 is engaged with the second end 252 of the inner sleeve 25, and has a second through-hole 2541. The first end 221 and the second end 222 of the inner shaft 22 pass through the first through-hole 2531 and the second through-hole 2541, respectively.

This embodiment includes the first metal strip roll 23 and the second metal strip roll 24. However, it is understood that the objective of the present invention can also be achieved with a single metal strip roll. The first metal strip roll 23 and the second metal strip roll 24 are wound around the inner shaft 22. The first metal strip roll 23 has a first end 231 and a second end 232. The second metal strip roll 24 has a first end 241 and a second end 242. The first ends 231, 241 are fixed to the inner shaft 22, and the second ends 232, 242 are used to drive the winding roller 21 to rotate relative to the inner shaft 22. In this embodiment, the first end 231 of the first metal strip roll 23 and the first end 241 of the second metal strip roll 24 are inserted in the first slot 223 of the inner shaft 22. The second end 232 of the first metal strip roll 23 and the second end 242 of the second metal strip roll 24 are fixed to the inner sleeve 25. Preferably, the second end 232 of the first metal strip roll 23 and the second end 242 of the second metal strip roll 24 are inserted in the corresponding second slot 255 of the inner sleeve 25. It is understood that the second end 232 of the first metal strip roll 23 and the second end 242 of the second metal strip roll 24 may be fixed to the winding roller 21 directly so that the inner sleeve 25 is omitted.

The screen 26 is wound around the winding roller 21. In the present invention, the screen 26 may be a window curtain or a cloth screen for a projector. The screen 26 has a first end (not shown) and a second end 262; the first end is fixed to the winding roller 21, and the second end 262 is a free end. The bottom cross bar 29 is located at the second end 262 of the screen 26.

The first support frame 27 has a first receiving hole 271 and a cylinder 272. The second support frame 28 has a second receiving hole 281. The first receiving hole 271 receives and confines one end of the inner shaft 22. The second receiving hole 281 receives the short pin 2131.

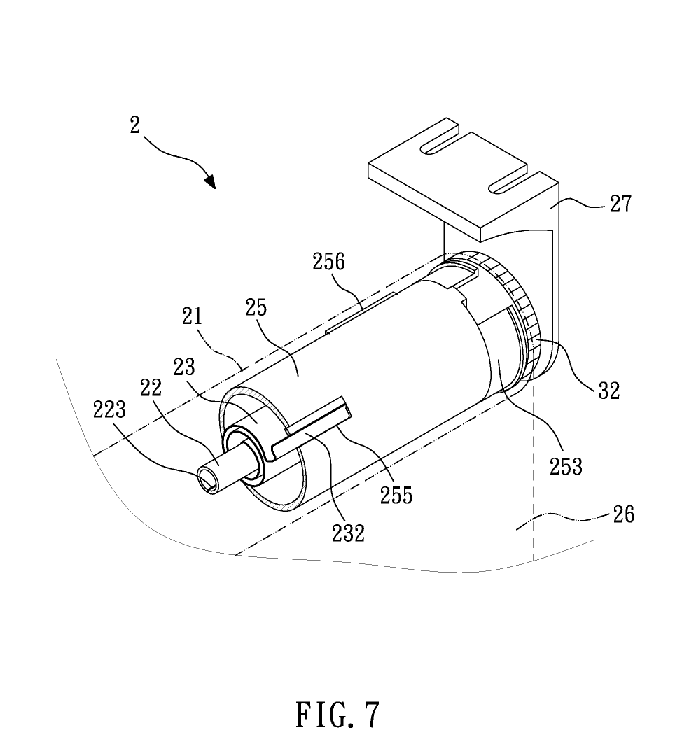

FIG. 7 shows the operation of a screen rolling device according to the present invention. In this embodiment, the first end 231 of the first metal strip roll 23 and the first end 241 of the second metal strip roll 24 are inserted in the first slot 223 of the inner shaft 22, the second end 232 of the first metal strip roll 23 and the second end 242 of the second metal strip roll 24 are inserted in the corresponding second slot 255 of the inner sleeve 25, and the protrusion 256 of the inner sleeve 25 is engaged with the retaining slot 214 of the winding roller 21. Therefore, when the user pulls down the bottom cross bar 29 manually to cause the winding roller 21 to rotate, the inner shaft 22 is stationary, so that the first metal strip roll 23 and the second metal strip roll 24 are tightly wound up to generate a restoring force. When the screen 26 is unrolled to a desired length, the restoring force in the first metal strip roll 23 and the second metal strip roll 24 is in equilibrium with the gravities of the unrolled screen 26 and the bottom cross bar 29, so that after the user releases the bottom cross bar 29, the bottom cross bar 29 immediately stops moving (i.e., the winding roller 21 does not rotate). Meanwhile, the unrolled length of the screen 26 is desirable and does not need further adjustment.

In the present invention, preferably, the first support frame 27 further has a tension adjustment device 30.

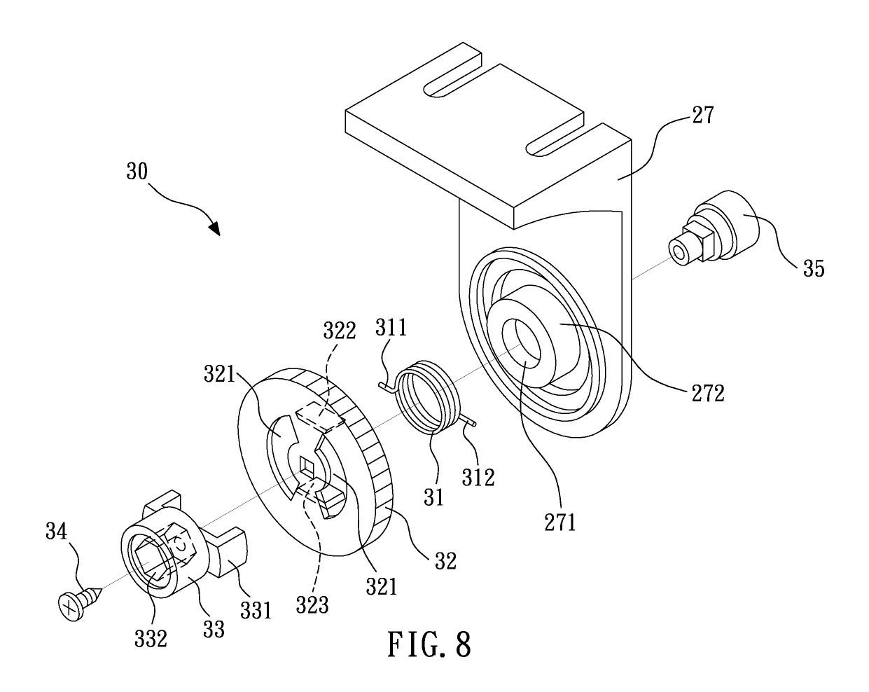

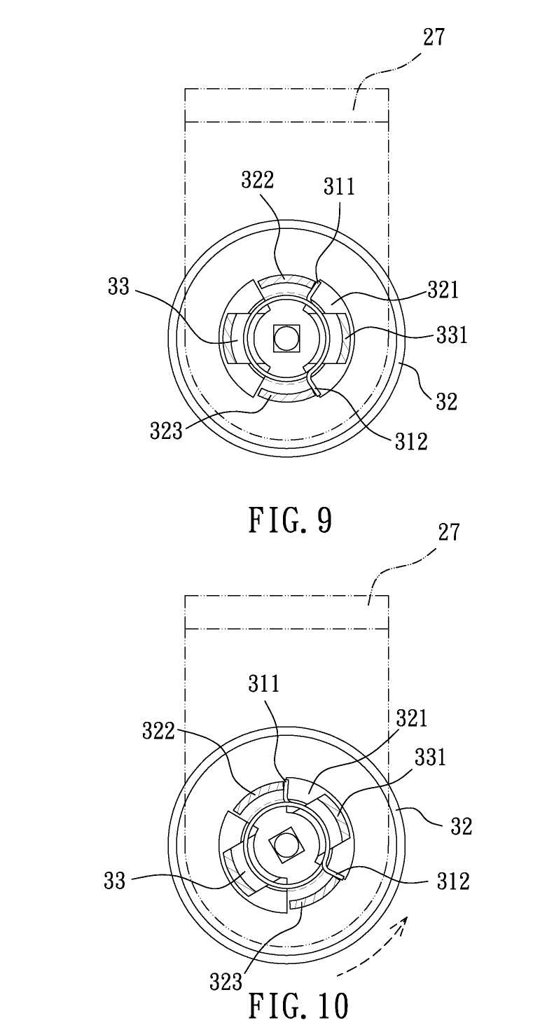

FIG. 8 is a perspective exploded view of a tension adjustment device according to the present invention. The tension adjustment device 30 comprises a spring 31, an adjustment swivel 32, a receiving pillar 33, a screw 34 and a fixed mount 35. The spring 31 is wound around the cylinder 272, and has a first end 311 and a second end 312 both extending radially. The adjustment swivel 32 covers the cylinder 272 and the spring 31, and has at least one third slot 321, a first abutting block 322 and a second abutting block 323. The first abutting block 322 and the second abutting block 323 press against the first end 311 and the second end 312 of the spring 31, respectively (FIG. 9).

The receiving pillar 33 has at least one third abutting block 331 and a third receiving hole 332. The third abutting block 331 extends into the third slot 321 of the adjustment swivel 32, and is located between the first end 311 and second end 312 of the spring 31. The third receiving hole 332, corresponding to the first receiving hole 271, receives and confines one end of the inner shaft 22. In this embodiment, the third receiving hole 332 is hexagonal, and the first end 221 of the inner shaft 22 is in the shape of a hexagonal column, so that the first end 221 of the inner shaft 22 is inserted in and engaged with the third receiving hole 332. It is understood that if the tension adjustment device 30 is omitted, the first end 221 of the inner shaft 22 is inserted in and engaged with the first receiving hole 271. The screw 34 secures the receiving pillar 33, the adjustment swivel 32, and the spring 31 to the fixed mount 35.

FIGS. 9 and 10 shows the operation of the tension adjustment device according to the present invention. As shown in FIG. 9, the first abutting block 322 and the second abutting block 323 of the adjustment swivel 32 press against the first end 311 and the second end 312 of the spring 31, respectively. As shown in FIG. 10, when the adjustment swivel 32 rotates in the arrow direction, the second abutting block 323 presses against the second end 312 of the spring 31, and the spring 31 is slightly loosened and becomes rotatable. Thus, when the adjustment swivel 32 continues to rotate, the second abutting block 323 and the second end 312 of the spring 31 may be in contact with the third abutting block 331 of the receiving pillar 33 and drive the receiving pillar 33 to rotate. Meanwhile, the third abutting block 331 of the receiving pillar 33 will be restricted between the first end 311 and the second end 312 of the spring 31. Thus, if the receiving pillar 33 rotates clockwise, the third abutting block 331 will press against the second end 312 of the spring 31, and the spring 31 will be tightened firmly on the cylinder 272 and stop rotating. If the receiving pillar 33 rotates counterclockwise, the third abutting block 331 will press against the first end 311 of the spring 31, and the spring 31 will be tightened firmly on the cylinder 272 and stop rotating. Therefore, the angle of the inner shaft 22 can be changed by rotating the adjustment swivel 32, so as to adjust the tension on the first metal strip roll 23 and the second metal strip roll 24.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. A screen rolling device, comprising:
a winding roller;
an inner shaft, located in the winding roller;
at least one metal strip roll, wound around the inner shaft and having a first end and a second end, wherein the first end of the metal strip roll is fixed to the inner shaft, and the second end of the metal strip roll drives the winding roller to rotate relative to the inner shaft; and
a screen, wound around the winding roller and having a first end and a second end, wherein the first end of the screen is fixed to the winding roller, and the second end of the screen is a free end.

2. The device according to claim 1, wherein the inner shaft has a first slot, and the first end of the metal strip roll is inserted in the first slot of the inner shaft.

3. The device according to claim 1, wherein the second end of the metal strip roll is fixed to the winding roller directly.

4. The device according to claim 1, further comprising an inner sleeve, wherein the inner shaft and the metal strip roll are located in the inner sleeve, the second end of the metal strip roll is fixed to the inner sleeve, and the inner sleeve is engaged with the winding roller, so that the inner sleeve and the winding roller are enabled to rotate simultaneously.

5. The device according to claim 4, wherein the inner sleeve has at least one protrusion on a surface thereof, the winding roller has at least one retaining slot, and the protrusion of the inner sleeve is engaged with the retaining slot of the winding roller.

6. The device according to claim 4, wherein the inner sleeve further comprises a second slot, and the second end of the metal strip roll is inserted in the second slot of the inner sleeve.

7. The device according to claim 4, wherein the inner sleeve further comprises a first end, a second end, a first side cover and a second side cover, the inner shaft further comprises a first end and a second end, the first side cover is engaged with the first end of the inner sleeve and has a first through-hole, the second side cover is engaged with the second end of the inner sleeve and has a second through-hole, and the first end and the second end of the inner shaft pass through the first through-hole and the second through-hole, respectively.

8. The device according to claim 1, further comprising a first support frame and a second support frame, wherein the first support frame has a first receiving hole, the second support frame has a second receiving hole, and the first receiving hole receives and confines one end of the inner shaft.

9. The device according to claim 8, wherein the winding roller has a first end, a second end and a third side cover, the third side cover has a short pin, the third side cover is engaged with the second end of the winding roller, the axis of the short pin is the same as that of the winding roller, and the second receiving hole receives the short pin.

10. The device according to claim 8, wherein the first support frame comprises a cylinder and a tension adjustment device, the tension adjustment device comprises a spring, an adjustment swivel, and an receiving pillar, the spring is wound around the cylinder and has a first end and a second end both extending radially, the adjustment swivel covers the cylinder and has at least one third slot, a first abutting block and a second abutting block, the first abutting block and the second abutting block respectively press against the first end and the second end of the spring, the receiving pillar has at least one third abutting block and a third receiving hole, the third abutting block extends into the third slot of the adjustment swivel and is located between the first end and the second end of the spring, and the third receiving hole corresponding to the first receiving hole receives and confines one end of the inner shaft.

11. The device according to claim 1, further comprising a bottom cross bar located at the second end of the screen.
